(19) United States
(12) Patent Application Publication
(10) Pub. No.: US 2025/0379522 A1
(43) Pub. Date: Dec. 11, 2025

(54) Voltage Conversion Circuit and Portable Power Source

(71) Applicant: Anker Innovations Technology Co., Ltd., Changsha (CN)

(72) Inventor: Mingkang Li, Shenzhen (CN)

(21) Appl. No.: 19/227,935

(22) Filed: Jun. 4, 2025

(30) Foreign Application Priority Data
Jun. 6, 2024 (CN) 202421299949.1

(51) Int. Cl. H02M 3/158; H02J 7/00; H02M 1/00

(52) U.S. Cl. CPC H02M 3/1582; H02J 7/0047; H02J 7/0063; H02J 7/0068; H02M 1/0048; H02M 1/008; H02J 2207/20

(57) ABSTRACT

A voltage conversion circuit and a portable power source are described herein. The voltage conversion circuit may include a first DCDC converter, with a first terminal connected to a battery and a second terminal connected to a first charging interface; a second DCDC converter connected in parallel to the first DCDC converter, with a first terminal connected to the battery and a second terminal connected to a second charging interface. A switch assembly may be connected in parallel between the first DCDC converter and the second DCDC converter. A microprocessor may enable at least one of the first DCDC converter and the second DCDC converter to be in operation by controlling the on/off of the switch assembly. This assembly may share heat losses between the DCDC converters in a small volume package.

### TECHNICAL FIELD

The present application relates to the technical field of portable power sources, in particular to a voltage conversion circuit and a portable power source.

### BACKGROUND

With the continuous advancement and development of technology, various electronic products are constantly iterated and updated. Electronic products have become indispensable and important devices in people's social life. For example, computers, mobile phones, and headphones provide education and entertainment functions for people. As the electronic products become increasingly close to people's lives, their battery life has become a focus of attention. Specifically, small-sized portable electronic devices have smaller batteries than non-portable electronic devices such as desktop computers or televisions. Therefore, portable power sources are usually used to charge the electronic devices.

At present, the mainstream development trend of portable power sources may be “high power and miniaturization.” As the power increases, DC-to-DC (“DCDC”) converters for voltage conversion bear increasing current stress, losses on conversion lines increase, and heat may be emitted sharply, so that the portable power sources cannot be small-sized. Meanwhile, high working temperatures caused by high losses threaten cell safety and increase housing temperature to affect user experience.

### SUMMARY

Aspects described herein may relate to a voltage conversion circuit and a portable power source, which may solve the problem of high heat losses caused by high-power charging of existing mobile power sources.

A voltage conversion circuit may include a first DCDC converter, where a first terminal of the first DCDC converter may be connected to a battery, and a second terminal of the first DCDC converter may be connected to a first charging interface. A second DCDC converter may be connected in parallel to the first DCDC converter, where a first terminal of the second DCDC converter may be connected to the battery, and a second terminal of the second DCDC converter may be connected to a second charging interface. The first charging interface and the second charging interface may be connected to external power sources or external devices. A switch assembly may be connected in parallel between the first DCDC converter and the second DCDC converter. A microprocessor may be connected to the switch assembly, where the microprocessor may be configured to enable at least one of the first DCDC converter and the second DCDC converter to be in operation by controlling the on/off of the switch assembly.

The switch assembly may include a first switch tube, a second switch tube, and/or a third switch tube. A control terminal of the first switch tube may be connected to the microprocessor to receive a first control signal. The first control signal may be output by the microprocessor. A first terminal of the first switch tube may be connected to the second terminal of the first DCDC converter, and a second terminal of the first switch tube may be connected to the first charging interface. A control terminal of the second switch tube may be connected to the microprocessor to receive a second control signal, where the second control signal may be output by the microprocessor. A first terminal of the second switch tube may be connected to the second terminal of the second DCDC converter, and a second terminal of the second switch tube may be connected to the second charging interface. A control terminal of the third switch tube may be connected to the microprocessor to receive a third control signal, where the third control signal may be output by the microprocessor. A first terminal of the third switch tube may be connected to the first terminal of the first switch tube, and a second terminal of the third switch tube may be connected to the first terminal of the second switch tube.

The voltage conversion circuit further may include a voltage and current sampling apparatus, and the voltage and current sampling apparatus may be connected in series between the first DCDC converter and the first charging interface for detecting a first output current of the first DCDC converter. The voltage and current sampling apparatus may be connected in series between the second DCDC converter and the second charging interface for detecting a second output current of the second DCDC converter. The microprocessor may receive the first output current and the second output current output by the voltage and current sampling apparatus and may adjust output voltages of the first DCDC converter and/or the second DCDC converter based on the first output current, the second output current, and/or an operating state of the third switch tube.

The voltage and current sampling apparatus may include a first voltage and current sampling apparatus and a second voltage and current sampling apparatus. Two terminals of the first voltage and current sampling apparatus may be connected to the second terminal of the first DCDC converter and the first terminal of the first switch tube respectively. Two terminals of the second voltage and current sampling apparatus may be connected to the second terminal of the second DCDC converter and the first terminal of the second switch tube respectively.

The switch assembly may further include a fourth switch tube. A control terminal of the fourth switch tube may be connected to the microprocessor to receive a fourth control signal, where the fourth control signal may be output by the microprocessor. A first terminal of the fourth switch tube may be connected to the first terminal of the first DCDC converter, and a second terminal of the fourth switch tube may be connected to the first terminal of the second DCDC converter.

The voltage conversion circuit further may include a third voltage and current sampling apparatus. A first terminal of the third voltage and current sampling apparatus may be connected to the battery, a second terminal of the third voltage and current sampling apparatus may be connected to the first terminal of the first DCDC converter and the first terminal of the fourth switch tube, and the third voltage and current sampling apparatus may be configured to detect an input current of the battery; where the microprocessor receives the input current and outputs the fourth control signal based on the input current.

The first voltage and current sampling apparatus, the second voltage and current sampling apparatus, and/or the third voltage and current sampling apparatus may be sampling resistors, current sensors, and/or voltage sensors.

The voltage conversion circuit further may include a fourth voltage and current sampling apparatus and a fifth voltage and current sampling apparatus. The fourth voltage and current sampling apparatus may be connected in series between the first charging interface and a ground terminal. The fourth voltage and current sampling apparatus may be configured to monitor a current of the first charging interface. The fifth voltage and current sampling apparatus may be connected in series between the second charging interface and the ground terminal. The fifth voltage and current sampling apparatus may be configured to monitor a current of the second charging interface.

The first DCDC converter and the second DCDC converter may be BUCK-BOOST converters.

Aspects described herein also relate to a portable power source, including at least two charging interfaces, a battery, and/or the voltage conversion circuit as described above. The voltage conversion circuit may be electrically connected to the at least two charging interfaces and the battery. The portable power source may receive input currents from one or more of the at least two charging interfaces through the voltage conversion circuit, and/or may output an output current of the battery using one or more of the at least two charging interfaces through the voltage conversion circuit.

The voltage conversion circuit of the present application may include the first DCDC converter and/or a second DCDC converter arranged in parallel, and the switch assembly may be arranged in parallel between the first DCDC converter and the second DCDC converter. The microprocessor may control the on-off of the switch assembly, so that at least one of the first DCDC converter and the second DCDC converter may be in operation. The first DCDC converter and the second DCDC converter might be capable of outputting current simultaneously. The first DCDC converter and the second DCDC converter in parallel might be capable of sharing a heat loss produced by a single DCDC converter during high-power charging, achieving a better heat sharing effect and meeting a demand for small-volume heat dissipation.

The above general description and the following detailed description are exemplary and explanatory only and do not limit the present application.

### BRIEF DESCRIPTION OF THE DRAWINGS

To describe the technical solutions in the examples of the present application more clearly, the following briefly introduces the accompanying drawings. The accompanying drawings in the following description show only some examples of the present application.

FIG. 1 is a schematic structural diagram of a voltage conversion circuit;

FIG. 2a is a schematic structural diagram of the voltage conversion circuit;

FIG. 2b is another schematic structural diagram of the voltage conversion circuit;

FIG. 3 is a schematic structural diagram of the voltage conversion circuit;

FIG. 4 is a schematic structural diagram of the voltage conversion circuit;

FIG. 5 is a schematic diagram of a specific circuit structure of a first DCDC converter;

FIG. 6 is a schematic diagram of a specific circuit structure of a second DCDC converter; and

FIG. 7 is a schematic structural diagram of a portable power source.

### DETAILED DESCRIPTION

Various aspects of the present disclosure, such as the voltage conversion circuit and the portable power source, will be further described in detail below with reference to the accompanying drawings and specific examples. The described examples are only some of the examples of the present application. A wide variety of examples other than those provided below fall within the scope of protection of the present application.

The terms “first,” “second,” etc. in the present application are used for distinguishing different objects, not for describing a specific order. In addition, the term “include” and “have” and any variants thereof cover a non-exclusive inclusion. For example, a process, method, system, product, or device including a series of steps or units might not be limited to the listed steps or units, but might optionally further may include unlisted steps or units, or optionally further may include other steps or units.

When existing portable power sources are used for high-power charging, DCDC converters for voltage conversion bear increasing current stress, which may result in high losses on conversion lines and sharp heat emission, making the sizes of portable power sources larger. Meanwhile, high working temperatures caused by the high losses might threaten cell safety and may increase housing temperature to affect user experience. Based on such problems, the present application provides, among other things, a voltage conversion circuit, where two DCDC converters arranged in parallel may be controlled to output current simultaneously and share heat losses, which may achieve a better heat sharing effect and meeting a demand for small-volume heat dissipation.

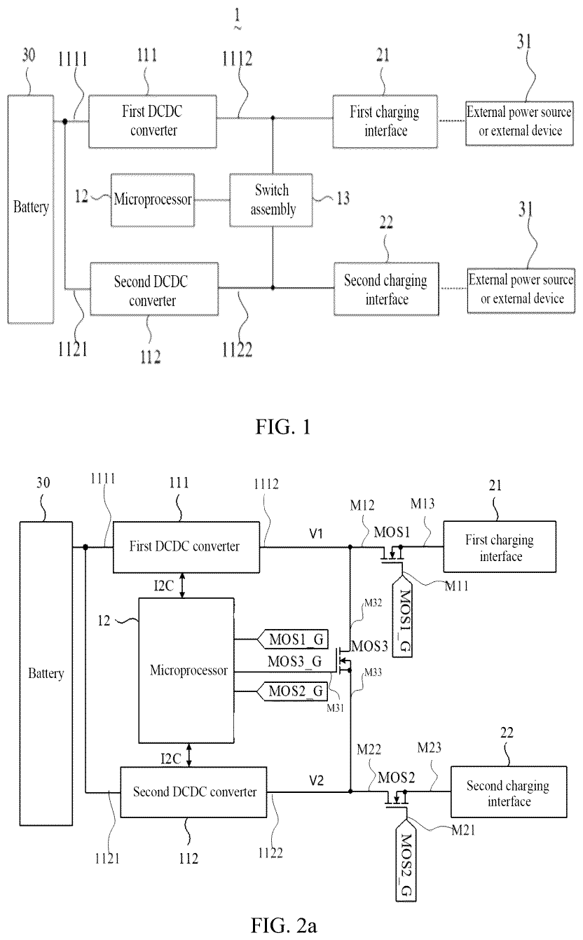

FIG. 1 comprises an illustrative schematic structural diagram of a voltage conversion circuit. As shown in FIG. 1, a voltage conversion circuit 1 in this example may include a first DCDC converter 111, a second DCDC converter 112, a microprocessor 12, and/or a switch assembly 13. The voltage conversion circuit 1 in this example may be connected between a battery 30 and a charging interface (e.g., a first charging interface 21 and a second charging interface 22), and may be used to convert a first charging voltage input from the charging interface to charge the battery 30; and/or the voltage conversion circuit 1 in this example may be used to convert a second charging voltage output by the battery 30 to charge an electronic device connected to the charging interface.

The charging interface in this example may include a first charging interface 21 and/or a second charging interface 22, which may be connected to different external devices or external power sources respectively.

For example, a first terminal 1111 of the first DCDC converter 111 may be connected to the battery 30, and a second terminal 1112 of the first DCDC converter 111 may be connected to the first charging interface 21 and then connected to an external power source or an external device through the first charging interface 21. The external power source connected to the first charging interface 21 may be used to charge the battery 30, and/or the battery 30 charges the external device connected to the first charging interface 21.

The second DCDC converter 112 may be arranged in parallel to the first DCDC converter 111, a first terminal 1121 of the second DCDC converter 112 may be connected to the battery 30, and a second terminal 1122 of the second DCDC converter 112 may be connected to the second charging interface 22 and then connected to an external power source or an external device through the second charging interface 22. The external power source connected to the second charging interface 22 may be used to charge the battery 30, and/or the battery 30 charges the external device connected to the second charging interface 22.

The external devices connected to the first charging interface 21 and/or the second charging interface 22 in this example may be of the same type or different types, and the first DCDC converter 111 and the second DCDC converter 112 may operate independently. When the first DCDC converter 111 charges the first external device through the first charging interface 21, the second DCDC converter 112 might simultaneously charge the second external device through the second charging interface 22.

The switch assembly 13 may be connected in parallel between the first DCDC converter 111 and the second DCDC converter 112. For example, two terminals of the switch assembly 13 may be connected to the first terminal of the first DCDC converter 111 and the second terminal of the second DCDC converter 112 respectively. By controlling the switch assembly 13, whether the battery 30 receives charging current input by the first DCDC converter 111 and the second DCDC converter 112 may be controlled, and the magnitude of charging voltage received by the battery 30 may be controlled. Additionally and/or alternatively, the two terminals of the switch assembly 13 may be connected to the second terminal 1112 of the first DCDC converter 111 and the second terminal 1122 of the second DCDC converter 112 respectively. By controlling the switch assembly 13, the operation of the corresponding DCDC converter connected to the external device may be controlled.

The microprocessor 12 may be connected to the switch assembly 13, and may enable at least one of the first DCDC converter 111 and the second DCDC converter 112 to be in operation by controlling the on/off of the switch assembly 13. For example, when only a single external device may be connected to the voltage conversion circuit 1 through the first charging interface 21 or the second charging interface 22, the microprocessor 12 might control the first DCDC converter 111 or the second DCDC converter 112 corresponding to the external device to be in operation so as to convert the second charging voltage output by the battery 30 into a rated charging voltage of the external device and complete the charging of the external device.

Both the first charging interface 21 and the second charging interface 22 in this example may be TYPE-C interfaces. For instance, when a single external device may be connected to the voltage conversion circuit 1, the battery 30 might also achieve high-power charging of the external device through the first charging interface 21 and/or the second charging interface 22, improving charging efficiency.

The first DCDC converter 111 and the second DCDC converter 112 designed to be parallel might share a heat loss produced by a single DCDC converter during high-power charging, thereby possibly achieving a better heat sharing effect.

One of the many benefits of the disclosure herein is miniaturization of filter inductors/capacitors through the parallel operation of the first DCDC converter 111 and the second DCDC converter 112. Moreover, because the parallel architecture of the first DCDC converter 111 and the second DCDC converter 112 can be applied to low-voltage input and high-power output scenarios, the requirement for more battery strings might be reduced compared to conventional high-power output solutions, and fewer cell strings may be used under the same power output conditions, thereby potentially achieving an effect of reducing volume. In turn, this means that an electronic device using the voltage conversion circuit 1 of the present application may have a small volume and achieve a good heat dissipation effect.

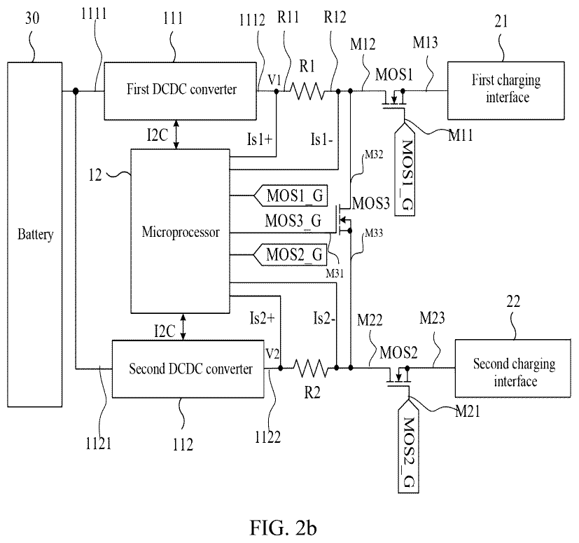

FIG. 2a comprises an illustrative schematic structural diagram of the voltage conversion circuit. As shown in FIG. 2a, the switch assembly 13 in this example may include a first switch tube MOS1, a second switch tube MOS2, and/or a third switch tube MOS3. The first switch tube MOS1, the second switch tube MOS2, and/or the third switch tube MOS3 may be NMOS transistors, PMOS transistors, and/or other switch elements capable of turning on or off the circuit.

For instance, a control terminal M11 of the first switch tube MOS1 may be connected to the microprocessor 12 to receive a first control signal MOS1_G, where the first control signal may be output by the microprocessor 12. A first terminal M12 of the first switch tube MOS1 may be connected to the second terminal 1112 of the first DCDC converter 111, and a second terminal M13 of the first switch tube MOS1 may be connected to the first charging interface 21.

A control terminal M21 of the second switch tube MOS2 may be connected to the microprocessor 12 to receive a second control signal MOS2_G. The second control signal may be output by the microprocessor 12. A first terminal M21 of the second switch tube MOS2 may be connected to the second terminal 1122 of the second DCDC converter 112, and a second terminal M23 of the second switch tube MOS2 may be connected to the second charging interface 22.

A control terminal M31 of the third switch tube MOS3 may be connected to the microprocessor 12 to receive a third control signal MOS3_G, where the third control signal may be output by the microprocessor 12. A first terminal M32 of the third switch tube MOS3 may be connected to the first terminal M12 of the first switch tube MOS1, and a second terminal M33 of the third switch tube MOS3 may be connected to the first terminal M21 of the second switch tube MOS2.

As shown in FIG. 2b, the voltage conversion circuit 1 further may include a voltage and current sampling apparatus. The voltage and current sampling apparatus may be connected in series between the first DCDC converter 111 and the first charging interface 21 for detecting a first output current (Is1+, Is1−) of the first DCDC converter 111. The voltage and current sampling apparatus may be connected in series between the second DCDC converter 112 and the second charging interface 22 for detecting a second output current (Is2+, Is2−) of the second DCDC converter 112.

The microprocessor 12 may receive the first output current and the second output current from the voltage and current sampling apparatus, adjust output voltages of the first DCDC converter 111 and/or the second DCDC converter 112 (V1 for the first DCDC converter 111 and V2 for the second DCDC converter 112) based on the first output current, the second output current, and/or an operating state of the third switch tube MOS3, and may then adjust an output power of each DCDC converter so as to ensure that the output powers of the two DCDC converters are not greatly different and ultimately reach a balanced state. This may make the resulting heat losses evenly distributed to the two DCDC converters.

As shown in FIG. 2b, the voltage and current sampling apparatus in this example may include a first voltage and current sampling apparatus R1 and a second voltage and current sampling apparatus R2. Two terminals (R11 and R12) of the first voltage and current sampling apparatus R1 may be connected to the second terminal 1112 of the first DCDC converter 111 and the first terminal M12 of the first switch tube MOS1 respectively. One terminal R11 of the first voltage and current sampling apparatus R1 may be connected to the second terminal 1112 of the first DCDC converter 111, and the other terminal R12 may be connected to the first terminal M12 of the first switch tube MOS1. Two terminals (R21 and R22) of the second voltage and current sampling apparatus R2 may be connected to the second terminal 1122 of the second DCDC converter 112 and the first terminal M21 of the second switch tube MOS2 respectively. One terminal R21 of the second voltage and current sampling apparatus R2 may be connected to the second terminal of the second DCDC converter 112, and the other terminal R22 may be connected to the first terminal M21 of the second switch tube MOS2.

The first voltage and current sampling apparatus R1 and/or the second voltage and current sampling apparatus R2 may be sampling resistors, current sensors, and/or voltage sensors.

In this example, the first voltage and current sampling apparatus R1 and the second voltage and current sampling apparatus R2 may be sampling resistors. The first output current may include currents Is1+ and Is1− at the two terminals of the first voltage and current sampling apparatus R1, and may be further combined with a resistance value of the first voltage and current sampling apparatus R1 to calculate the output voltage V1 of the first DCDC converter 111. The second output current may include currents Is2+ and Is2− at the two terminals of the second voltage and current sampling apparatus R2, and may be further combined with a resistance value of the second voltage and current sampling apparatus R2 to calculate the output voltage V2 of the second DCDC converter 112.

The microprocessor 12 may be connected to the two terminals (R11 and R12) of the first voltage and current sampling apparatus R1 and the two terminals (R21 and R12) of the second voltage and current sampling apparatus R2. The microprocessor may receive the first output current output by the first voltage and current sampling apparatus R1, namely, currents Is1+ and Is1− at the two terminals of the first voltage and current sampling apparatus R1, and may receive the second output current output by the second voltage and current sampling apparatus R2, namely, currents Is2+ and Is2− at the two terminals of the second voltage and current sampling apparatus R2.

The microprocessor 12 in this example may monitor the first output current and the second output current, and may transmit control signals to the first DCDC converter 111 and/or the second DCDC converter 112 in real time through I2C communication to adjust the output voltage of each DCDC converter.

When the single charging interface outputs a high power and the dual DCDC converters operate in parallel, the microprocessor 12 may control the third switch tube MOS3 to turn on, may control one of the first switch tube MOS1 or the second switch tube MOS2 to turn on, and/or may control the other of the first switch tube MOS1 or the second switch tube MOS2 to turn off. In such an example, the output powers of the two DCDC converters might be combined into one output port.

When the first charging interface 21 and the second charging interface 22 need to output voltages simultaneously, the microprocessor 12 may control the third switch tube MOS3 to turn off and may control both the first switch tube MOS1 and the second switch tube MOS2 to turn on, thereby potentially achieving independent operation of the two DCDC converters. The microprocessor 12 may perform independent control through each sampling signal.

According to the voltage conversion circuit 1 in this example, the two DCDC converters may operate in parallel, and the microprocessor 12 may distribute the power of the charging interface through dual parallel or independent operation by monitoring the signals collected by the current and voltage sampling apparatus, thereby potentially achieving the purpose of parallel operation and flexible switching between single and dual operations, thereby potentially reducing the losses caused by the dual DCDC converters under no load or light load, and thereby potentially achieving optimal standby power consumption and light load losses. Compared to conventional single DCDC operation, the voltage conversion circuit 1 in this example may reduce the volumes of filter inductors/capacitors, lower the stress on power switching devices, and may reduce losses caused by high current, thereby improving the conversion efficiency of the voltage conversion circuit 1.

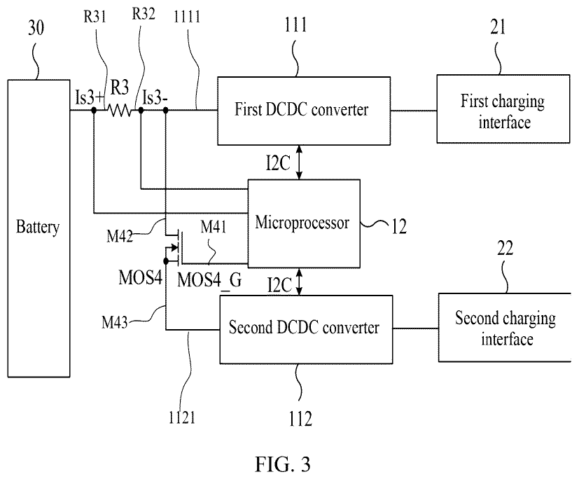

FIG. 3 comprises an illustrative schematic structural diagram of the voltage conversion circuit. As shown in FIG. 3, the switch assembly 13 in this example may include a fourth switch tube MOS4. A control terminal M41 of the fourth switch tube MOS4 may be connected to the microprocessor 12 to receive a fourth control signal MOS4_G, where the fourth control signal may be output by the microprocessor 12. A first terminal M42 of the fourth switch tube MOS4 may be connected to the first terminal 1111 of the first DCDC converter 111, and a second terminal M42 of the fourth switch tube MOS4 may be connected to the first terminal 1121 of the second DCDC converter 112.

As shown in FIG. 3, the voltage conversion circuit 1 in this example further may include a third voltage and current sampling apparatus R3. A first terminal R31 of the third voltage and current sampling apparatus R3 may be connected to the battery 30, a second terminal R32 of the third voltage and current sampling apparatus R3 may be connected to the first terminal of the first DCDC converter 111 and the first terminal M42 of the fourth switch tube MOS4, and the third voltage and current sampling apparatus may be configured to detect input currents (Is3+ and Is3−) of the battery 30. The microprocessor 12 may receive the input currents and outputs the fourth control signal MOS4_G based on the input currents.

In some examples, the third voltage and current sampling apparatus R3 may comprise a sampling resistor, a current sensor, and/or a voltage sensor. In such examples, the third voltage and current sampling apparatus R3 may be a sampling resistor. The input current may be currents Is3+ and Is3− at the two terminals of the third voltage and current sampling apparatus R3, and may be further combined with a resistance value of the third voltage and current sampling apparatus R3 to calculate an input voltage of the battery 30.

The microprocessor 12 may be connected to the two terminals of the third voltage and current sampling apparatus R3 to receive the input current of the battery 30. The input current may be output by the third voltage and current sampling apparatus R3, and the input current may include the currents Is3+ and Is3− at the two terminals of the third voltage and current sampling apparatus R3.

For example, the voltage conversion circuit 1 in this example may be connected to an external power source. When the battery 30 may be charged through the external power source, the microprocessor 12 may monitor the input current and controls the fourth switch tube MOS4 for parallel charging, potentially adapting to different charging power requirements, achieving flexible switching between single DCDC and dual DCDC operations, reducing the losses caused by the dual DCDC converters under no-load or light load, and achieving the optimal standby power consumption and light load losses.

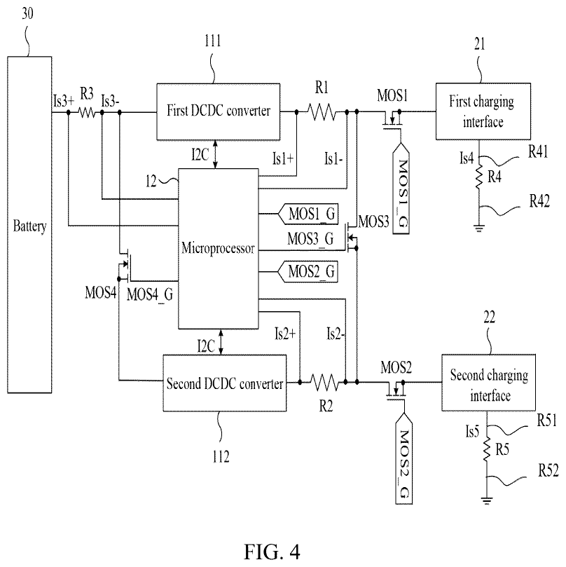

FIG. 4 comprises an illustrative schematic structural diagram of the voltage conversion circuit. As shown in FIG. 4, the voltage conversion circuit in this example may include the first switch tube MOS1, the second switch tube MOS2, the third switch tube MOS3, the first voltage and current sampling apparatus R1, and/or the second voltage and current sampling apparatus R2 as shown in FIG. 2, as well as the fourth switch tube MOS4 and/or the third voltage and current sampling apparatus R3 as shown in FIG. 3. The specific connection structures of the above circuit elements may be as described in the above examples.

For example, the voltage conversion circuit 1 in this example may be connected to an external power source. When the battery 30 may be charged through the external power source, the microprocessor 12 may monitor the input current, control the fourth switch tube MOS4 for parallel charging, and/or control the first switch tube MOS1 and the second switch tube MOS2 for conversion between single-port charging and dual-port charging, which may reduce the high losses of the DCDC converters caused by high current during high-power charging and improve the charging speed.

As shown in FIG. 4, the voltage conversion circuit 1 in this example further may include a fourth voltage and current sampling apparatus R4 and a fifth voltage and current sampling apparatus R5. The fourth voltage and current sampling apparatus R4 may be connected in series between the first charging interface 21 and a ground terminal. The fifth voltage and current sampling apparatus R5 may be connected in series between the second charging interface 22 and the ground terminal. In some examples, the fourth voltage and current sampling apparatus R4 and/or the fifth voltage and current sampling apparatus R5 may be sampling resistors, current sensors, and/or voltage sensors. In this example, the fourth voltage and current sampling apparatus R4 and the fifth voltage and current sampling apparatus R5 are specifically sampling resistors.

For instance, a first terminal R41 of the fourth voltage and current sampling apparatus R4 may be connected to the first charging interface 21, a second terminal R42 of the fourth voltage and current sampling apparatus R4 may be grounded, and/or the fourth voltage and current sampling apparatus R4 may be used to monitor a current Is4 of the first charging interface 21. A first terminal R51 of the fifth voltage and current sampling apparatus R5 may be connected to the second charging interface 22, a second terminal R52 of the fifth voltage and current sampling apparatus R5 may be grounded, and/or the fifth voltage and current sampling apparatus R5 may be used to monitor a current Is5 of the second charging interface 22.

In some examples, the microprocessor 12 may obtain the current Is4 of the first charging interface 21 and the current Is5 of the second charging interface 22 through the fourth voltage and current sampling apparatus R4 and/or the fifth voltage and current sampling apparatus R5. The voltage and current of the overall voltage conversion circuit 1 may be monitored by combining the current Is4 and the current Is5 with the first output current obtained through the first voltage and current sampling apparatus R1. The second output current may be obtained through the second voltage and current sampling apparatus R2, and the input current may be obtained through the third voltage and current sampling apparatus R3.

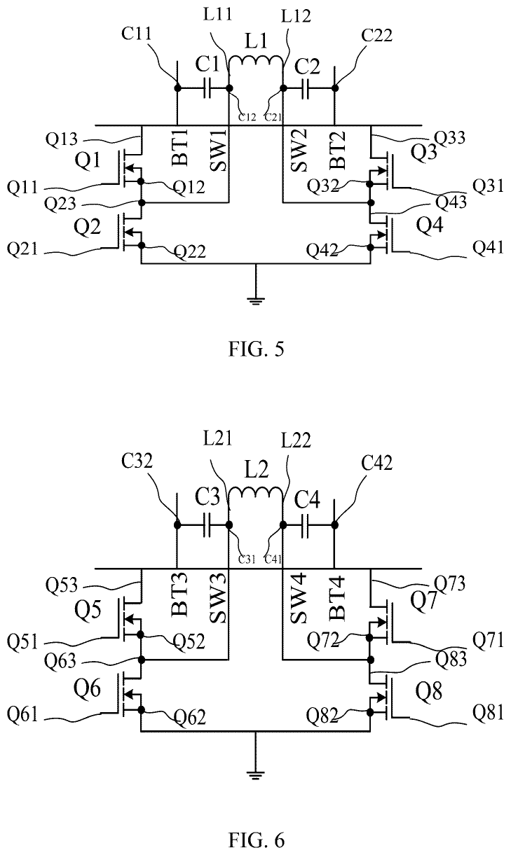

The first DCDC converter 111 and the second DCDC converter 112 in this example may be BUCK-BOOST converters. FIG. 5 may comprise an illustrative schematic diagram of a specific circuit structure of the first DCDC converter in the present application. FIG. 6 may comprise an illustrative schematic diagram of a specific circuit structure of the second DCDC converter in the present application.

As shown in FIG. 5, the first DCDC converter 111 may include an inductor L1, a capacitor C1, a capacitor C2, a switch tube Q1, a switch tube Q2, a switch tube Q3, and/or a switch tube Q4. A first terminal L11 of the inductor L1 may be connected to a first terminal C11 of the capacitor C1, a second terminal Q12 of the switch tube Q1, and/or a first terminal Q23 of the switch tube Q2. A second terminal L12 of the inductor L1 may be connected to a first terminal C21 of the capacitor C2, a second terminal Q32 of the switch tube Q3, and/or a first terminal Q43 of the switch tube Q4. A second terminal C12 of the capacitor C1 may be connected to a first terminal Q13 of the switch tube Q1, a second terminal C22 of the capacitor C2, and/or a first terminal Q33 of the switch tube Q3. A second terminal Q22 of the switch tube Q2 may be connected to a second terminal Q42 of the switch tube Q4 and/or further grounded.

As shown in FIG. 6, the second DCDC converter 112 may include an inductor L2, a capacitor C3, a capacitor C4, a switch tube Q5, a switch tube Q6, a switch tube Q7, and/or a switch tube Q8. A first terminal L21 of the inductor L2 may be connected to a first terminal C31 of the capacitor C3, a second terminal Q52 of the switch tube Q5, and/or a first terminal Q63 of the switch tube Q6. A second terminal L22 of the inductor L2 may be connected to a first terminal C41 of the capacitor C4, a second terminal Q72 of the switch tube Q7, and/or a first terminal Q83 of the switch tube Q8. A second terminal C32 of the capacitor C3 may be connected to a first terminal Q53 of the switch tube Q5, a second terminal C42 of the capacitor C4, and/or a first terminal Q73 of the switch tube Q7. A second terminal Q62 of the switch tube Q6 may be connected to a second terminal Q82 of the switch tube Q8 and/or further grounded.

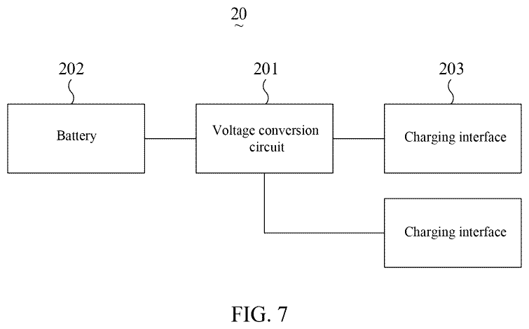

Aspects described herein further relate to a portable power source. FIG. 7 may comprise an illustrative schematic structural diagram of a portable power source. As shown in FIG. 7, the portable power source 20 in this example may include at least two charging interfaces 203, a battery 202, and/or a voltage conversion circuit 201. The charging interfaces 203 in this example may be the first charging interface 21 and/or the second charging interface 22 described in any of the above examples, the battery 202 may be the battery 30 described in any of the above examples, and/or the voltage conversion circuit 201 may be the voltage conversion circuit 1 described in any of the above examples.

The voltage conversion circuit 201 in the example provided in FIG. 7 may be electrically connected to the at least two charging interfaces 203 and the battery 202. The portable power source 20 may receive input currents from one or more of the at least two charging interfaces 203 through the voltage conversion circuit 201 to charge the battery 202, and/or the portable power source 20 may output an output current of the battery 202 using one or more of the at least two charging interfaces 203 through the voltage conversion circuit 201 to charge an external device. The external device may be connected to the charging interface 203.

Described above are only the examples of the present disclosure, and the patent scope of the patent disclosure may be not limited thereto. Any equivalent structure or equivalent process transformation made using the description and accompanying drawings of the present disclosure, directly or indirectly applied in other related technical fields, may be also included in the scope of patent protection of the present disclosure.

What is claimed is:

1. A voltage conversion circuit, comprising:
a first DCDC converter, wherein a first terminal of the first DCDC converter is connected to a battery, and wherein a second terminal of the first DCDC converter is connected to a first charging interface;
a second DCDC converter connected in parallel to the first DCDC converter, wherein a first terminal of the second DCDC converter is connected to the battery, wherein a second terminal of the second DCDC converter is connected to a second charging interface, and wherein the first charging interface and the second charging interface are connected to external power sources or external devices;
a switch assembly connected in parallel between the first DCDC converter and the second DCDC converter; and
a microprocessor connected to the switch assembly, wherein the microprocessor is configured to enable, based on operation of the switch assembly, at least one of the first DCDC converter and the second DCDC converter to be in operation.

2. The voltage conversion circuit according to claim 1, wherein the switch assembly comprises a first switch tube, a second switch tube, and a third switch tube, and wherein:
a control terminal of the first switch tube is connected to the microprocessor to receive a first control signal;
the first control signal is output by the microprocessor;
a first terminal of the first switch tube is connected to the second terminal of the first DCDC converter;
a second terminal of the first switch tube is connected to the first charging interface;
a control terminal of the second switch tube is connected to the microprocessor to receive a second control signal;
the second control signal is output by the microprocessor;
a first terminal of the second switch tube is connected to the second terminal of the second DCDC converter;
a second terminal of the second switch tube is connected to the second charging interface;
a control terminal of the third switch tube is connected to the microprocessor to receive a third control signal;
the third control signal is output by the microprocessor;
a first terminal of the third switch tube is connected to the first terminal of the first switch tube; and
a second terminal of the third switch tube is connected to the first terminal of the second switch tube.

3. The voltage conversion circuit according to claim 2, wherein:
the voltage conversion circuit further comprises a voltage and current sampling apparatus,
the voltage and current sampling apparatus is connected in series between the first DCDC converter and the first charging interface for detecting a first output current of the first DCDC converter,
the voltage and current sampling apparatus is connected in series between the second DCDC converter and the second charging interface for detecting a second output current of the second DCDC converter, and
the microprocessor is configured to:
receive, via the voltage and current sampling apparatus, the first output current and the second output current, and
adjust output voltages of the first DCDC converter and/or the second DCDC converter based on the first output current, the second output current, and an operating state of the third switch tube.

4. The voltage conversion circuit according to claim 2, wherein:
the voltage conversion circuit further comprises a voltage and current sampling apparatus,
the voltage and current sampling apparatus comprises a first voltage and current sampling apparatus and a second voltage and current sampling apparatus,
two terminals of the first voltage and current sampling apparatus are connected to the second terminal of the first DCDC converter and the first terminal of the first switch tube, and
two terminals of the second voltage and current sampling apparatus are connected to the second terminal of the second DCDC converter and the first terminal of the second switch tube.

5. The voltage conversion circuit according to claim 1, wherein:
the switch assembly further comprises a fourth switch tube,
a control terminal of the fourth switch tube is connected to the microprocessor to receive a fourth control signal,
the fourth control signal is output by the microprocessor,
a first terminal of the fourth switch tube is connected to the first terminal of the first DCDC converter, and
a second terminal of the fourth switch tube is connected to the first terminal of the second DCDC converter.

6. The voltage conversion circuit according to claim 5, wherein:
the voltage conversion circuit further comprises a third voltage and current sampling apparatus,
a first terminal of the third voltage and current sampling apparatus is connected to the battery,
a second terminal of the third voltage and current sampling apparatus is connected to the first terminal of the first DCDC converter and the first terminal of the fourth switch tube,
the third voltage and current sampling apparatus is configured to detect an input current of the battery, and
the microprocessor receives the input current and outputs the fourth control signal based on the input current.

7. The voltage conversion circuit according to claim 1, wherein the voltage conversion circuit comprises a first voltage and current sampling apparatus, a second voltage and current sampling apparatus, and a third voltage and current sampling apparatus, and wherein the first voltage and current sampling apparatus, the second voltage and current sampling apparatus, and the third voltage and current sampling apparatus are sampling resistors, current sensors, and/or voltage sensors.

8. The voltage conversion circuit according to claim 1, wherein:
the voltage conversion circuit further comprises a fourth voltage and current sampling apparatus and a fifth voltage and current sampling apparatus,
the fourth voltage and current sampling apparatus is connected in series between the first charging interface and a ground terminal,
the fourth voltage and current sampling apparatus is configured to monitor a current of the first charging interface,
the fifth voltage and current sampling apparatus is connected in series between the second charging interface and the ground terminal, and
the fifth voltage and current sampling apparatus is configured to monitor a current of the second charging interface.

9. The voltage conversion circuit according to claim 1, wherein either or both the first DCDC converter or the second DCDC converter are BUCK-BOOST converters.

10. A portable power source, wherein the portable power source comprises:
at least two charging interfaces,
a battery, and
a voltage conversion circuit comprising:
a first DCDC converter, wherein a first terminal of the first DCDC converter is connected to a battery, and wherein a second terminal of the first DCDC converter is connected to a first charging interface;
a second DCDC converter connected in parallel to the first DCDC converter, wherein a first terminal of the second DCDC converter is connected to the battery, wherein a second terminal of the second DCDC converter is connected to a second charging interface, and wherein the first charging interface and the second charging interface are connected to external power sources or external devices;
a switch assembly connected in parallel between the first DCDC converter and the second DCDC converter; and
a microprocessor connected to the switch assembly, wherein the microprocessor is configured to enable, based on operation of the switch assembly, at least one of the first DCDC converter and the second DCDC converter to be in operation,
wherein:
the voltage conversion circuit is electrically connected to the at least two charging interfaces and the battery,
the portable power source is configured to one or more of:
receive input currents from one or more of the at least two charging interfaces through the voltage conversion circuit, or
output an output current of the battery using one or more of the at least two charging interfaces through the voltage conversion circuit.

11. The portable power source according to claim 10, wherein the switch assembly comprises a first switch tube, a second switch tube, and a third switch tube, and wherein:
a control terminal of the first switch tube is connected to the microprocessor to receive a first control signal;
the first control signal is output by the microprocessor;
a first terminal of the first switch tube is connected to the second terminal of the first DCDC converter;
a second terminal of the first switch tube is connected to the first charging interface;
a control terminal of the second switch tube is connected to the microprocessor to receive a second control signal;
the second control signal is output by the microprocessor;
a first terminal of the second switch tube is connected to the second terminal of the second DCDC converter;
a second terminal of the second switch tube is connected to the second charging interface;
a control terminal of the third switch tube is connected to the microprocessor to receive a third control signal;
the third control signal is output by the microprocessor;
a first terminal of the third switch tube is connected to the first terminal of the first switch tube; and
a second terminal of the third switch tube is connected to the first terminal of the second switch tube.

12. The portable power source according to claim 10, wherein:
the voltage conversion circuit further comprises a voltage and current sampling apparatus,
the voltage and current sampling apparatus is connected in series between the first DCDC converter and the first charging interface for detecting a first output current of the first DCDC converter,
the voltage and current sampling apparatus is connected in series between the second DCDC converter and the second charging interface for detecting a second output current of the second DCDC converter, and
the microprocessor is configured to:
receive, via the voltage and current sampling apparatus, the first output current and the second output current, and
adjust output voltages of the first DCDC converter and/or the second DCDC converter based on the first output current, the second output current, and an operating state of a third switch tube.

13. The portable power source according to claim 11, wherein:
the voltage conversion circuit further comprises a voltage and current sampling apparatus,
the voltage and current sampling apparatus comprises a first voltage and current sampling apparatus and a second voltage and current sampling apparatus,
two terminals of the first voltage and current sampling apparatus are connected to the second terminal of the first DCDC converter and the first terminal of the first switch tube, and
two terminals of the second voltage and current sampling apparatus are connected to the second terminal of the second DCDC converter and the first terminal of the second switch tube.

14. The portable power source according to claim 10, wherein:
the switch assembly further comprises a fourth switch tube,
a control terminal of the fourth switch tube is connected to the microprocessor to receive a fourth control signal,
the fourth control signal is output by the microprocessor,
a first terminal of the fourth switch tube is connected to the first terminal of the first DCDC converter, and
a second terminal of the fourth switch tube is connected to the first terminal of the second DCDC converter.

15. The portable power source according to claim 14, wherein:
the voltage conversion circuit further comprises a third voltage and current sampling apparatus,
a first terminal of the third voltage and current sampling apparatus is connected to the battery,
a second terminal of the third voltage and current sampling apparatus is connected to the first terminal of the first DCDC converter and the first terminal of the fourth switch tube,
the third voltage and current sampling apparatus is configured to detect an input current of the battery, and
the microprocessor receives the input current and outputs a fourth control signal based on the input current.

16. The portable power source according to claim 10, wherein the voltage conversion circuit comprises a first voltage and current sampling apparatus, a second voltage and current sampling apparatus, and a third voltage and current sampling apparatus, and wherein the first voltage and current sampling apparatus, the second voltage and current sampling apparatus, and the third voltage and current sampling apparatus are sampling resistors, current sensors, and/or voltage sensors.

17. The portable power source according to claim 10, wherein:
the voltage conversion circuit further comprises a fourth voltage and current sampling apparatus and a fifth voltage and current sampling apparatus,
the fourth voltage and current sampling apparatus is connected in series between the first charging interface and a ground terminal,
the fourth voltage and current sampling apparatus is configured to monitor a current of the first charging interface,
the fifth voltage and current sampling apparatus is connected in series between the second charging interface and the ground terminal, and
the fifth voltage and current sampling apparatus is configured to monitor a current of the second charging interface.

18. The portable power source according to claim 10, wherein either or both the first DCDC converter or the second DCDC converter are BUCK-BOOST converters.

19. A voltage conversion circuit, comprising:
a first DCDC converter, wherein a first terminal of the first DCDC converter is connected to a first charging interface;
a second DCDC converter connected in parallel to the first DCDC converter, wherein a first terminal of the second DCDC converter is connected to a second charging interface, and wherein the first charging interface and the second charging interface are connected to external power sources or external devices; and
a microprocessor configured to selectively enable at least one of the first DCDC converter and the second DCDC converter.

20. The voltage conversion circuit according to claim 19, wherein a second terminal of the first DCDC converter and a second terminal of the second DCDC converter are connected to a battery.
